(19) United States
(12) Patent Application Publication
(10) Pub. No.: US 2023/0105937 A1
(43) Pub. Date: Apr. 6, 2023

(54) SYSTEMS AND METHODS FOR SEAMLESS RESET FOR SEAMLESS REDUNDANCY OF TSN/DETNET

(71) Applicant: Telefonaktiebolaget LM Ericsson (publ), Stockholm (SE)

(72) Inventors: Balázs Varga, Budapest (HU); János Farkas, Kecskemét (HU)

(21) Appl. No.: 17/911,151

(22) PCT Filed: Mar. 12, 2021
(86) PCT No.: PCT/EP2021/056306

§ 371 Date: Sep. 13, 2022

Related U.S. Application Data
(60) Provisional application No. 62/989,340, filed on Mar. 13, 2020.

(51) Int. Cl. H04L 1/1607; H04L 47/28; H04L 47/34; H04L 1/08

(52) U.S. Cl. CPC H04L 1/1642; H04L 47/28; H04L 47/34; H04L 1/08

(57) ABSTRACT

Systems and methods are disclosed herein for seamless reset for seamless redundancy. In one embodiment, a method performed by a transmit node comprises determining that a sequence generation function at the transmit node has been reset and, responsive thereto, transmitting first packets in a stream via at least two disjoint paths, wherein: (a) each of the first packets comprises a respective sequence number from a linear sequence number space and (b) at least a first packet from the first packets comprises an explicit indicator of the reset. The method further comprises determining that an end of the linear sequence number space has been reached or that use of the linear sequence number space has been disabled and, responsive thereto, transmitting second packets in the stream via at least two disjoint paths, wherein (a) each of the second packets comprises a respective sequence number of a cyclic sequence number space.

### RELATED APPLICATIONS

This application claims the benefit of provisional patent application Ser. No. 62/989,340, filed Mar. 13, 2020, the disclosure of which is hereby incorporated herein by reference in its entirety.

### TECHNICAL FIELD

The present disclosure relates to Time Sensitive Networking (TSN) and Deterministic Networking (DetNet) and, more specifically, to frame or packet replication and elimination in a TSN or DetNet network.

### BACKGROUND

Time-Sensitive Networking (TSN) is currently being developed at the Institute for Electronics and Electrical Engineering (IEEE) as a new technology that enhances IEEE 802.1 and IEEE 802.3 Ethernet standards to an entirely new level of determinism. It can be seen as an evolution of Ethernet to guarantee low end-to-end latency, low jitter, and low packet loss.

The TSN Task Group (TG) within the IEEE 802.1 Working Group (WG) deals with deterministic services through IEEE 802 networks. The TSN TG specifies the tools of the TSN toolbox, as well as the use of the tools for a particular purpose. TSN TG is chartered to provide deterministic services through IEEE 802 networks with:
guaranteed packet transport,
low packet loss,
bounded low latency, and
low packet delay variation.

In order to achieve extremely low packet loss, the TSN TG specified Frame Replication and Elimination for Reliability (FRER) (802.1CB), which is targeted to avoid frame loss due to equipment failure. It is practically a per-frame 1+1 (or 1+n) redundancy function. There is no failure detection/switchover incorporated. FRER sends frames on two (or more) maximally disjoint paths, then combines the streams and deletes extra frames.

Note that the same functions are defined for Deterministic Networking (DetNet) networks as Packet Replication and Elimination Functions (PREFs) in order to simplify implementation and allow use of the same concept in both Layer2 (TSN) and Layer3 (DetNet) networks. In the description provided herein, the focus is on FRER.

Note as per IEEE 802.1CB: “ . . . this standard defines Frame Replication and Elimination for Reliability (FRER), which divides a Stream into one or more linked Member Streams, thus making the original Stream a Compound Stream. It replicates the packets of the Stream, splitting the copies into the multiple Member Streams, and then rejoins those Member Streams at one or more other points, eliminates the replicates, and delivers the reconstituted Stream from those points.”

An Elimination function evaluates the “sequence_number” sub-parameter of a packet of one or more Member Streams passed up from the lower layers, in order to discard duplicated packets. The “SequenceHistory” variable maintains a history of the “sequence_number” sub-parameters of recently received packets. During duplicate elimination, “sequence_number” is checked against a history window (defined by “frerSeqRcvyHistoryLength”). Packets being outside the history window are discarded as invalid. Under normal operation, received packets are within the history window and only duplicates are dropped.

IEEE 802.1CB defines a timeout mechanism for the Elimination function in order to cope with some networking scenarios that results in unnecessarily dropped frames (e.g., if Elimination function somehow gets out of step with its corresponding Sequence generation function; if a Sequence generation function is reset; etc.). If a timeout occurs, the history is reset, and it is allowed to accept the next packet by the recovery algorithm, no matter what the value of its “sequence_number” sub-parameter (see “TakeAny” in 7.4.3.2.6 in IEEE 802.1CB).

### SUMMARY

Systems and methods are disclosed herein for seamless reset for seamless redundancy, e.g., of a Time-Sensitive Networking (TSN) network or a Deterministic Networking (DetNet) network. In one embodiment, a method performed by a transmit node for packet or frame replication comprises determining that a sequence generation function at the transmit node has been reset. The method further comprises, responsive to determining that the sequence generation function at the transmit node has been reset, transmitting a first plurality of packets in a stream of packets via at least two disjoint paths through a network, wherein: (a) each of the first plurality of packets comprises a respective sequence number from a linear sequence number space and (b) at least a first packet from among the first plurality of packets that was sent after the reset further comprises an explicit indicator of the reset. The method further comprises determining that an end of the linear sequence number space has been reached or that use of the linear sequence number space has been otherwise disabled. The method further comprises, responsive to determining that the end of the linear sequence number space has been reached or that use of the linear sequence number space has been otherwise disabled, transmitting a second plurality of packet in the stream of packets via at least two disjoint paths through the network, wherein (a) each of the second plurality of packets comprises a respective sequence number of a cyclic sequence number space. In this manner, seamless reset for sequence number generation is provided.

In one embodiment, each of the first plurality of packets further comprises an explicit indication that the linear sequence number space is being used.

In one embodiment, the network is a TSN network.

In one embodiment, the method further comprises resetting the sequence generation function, wherein resetting the sequence generation function comprises resetting a sequence number history, a history window, or both the sequence number history and the history window.

In one embodiment, the steps of determining that the sequence generation function at the transmit node has been reset, transmitting the first plurality of packets in the stream of packets, determining that the end of the linear sequence number space has been reached or that use of the linear sequence number space has been otherwise disabled, and transmitting the second plurality of packet in the stream of packets are performed by a Frame Replication and Elimination for Reliability (FRER) function of the transmit node.

In one embodiment, the network is a DetNet network. In one embodiment, the steps of determining that the sequence generation function at the transmit node has been reset, transmitting the first plurality of packets in the stream of packets, determining that the end of the linear sequence number space has been reached or that use of the linear sequence number space has been otherwise disabled, and transmitting the second plurality of packet in the stream of packets are performed by a Packet Replication and Elimination Function (PRER) of the transmit node.

Corresponding embodiments of a transmit node are also disclosed. In one embodiment, a transmit node for packet or frame replication is adapted to determine that a sequence generation function at the transmit node has been reset. The transmit node is further adapted to, responsive to determining that the sequence generation function at the transmit node has been reset, transmit a first plurality of packets in a stream of packets via at least two disjoint paths through a network, wherein: (a) each of the first plurality of packets comprises a respective sequence number from a linear sequence number space and (b) at least a first packet from among the first plurality of packets that was sent after the reset further comprises an explicit indicator of the reset. The transmit node is further adapted to determine that an end of the linear sequence number space has been reached or that use of the linear sequence number space has been otherwise disabled and, responsive to determining that the end of the linear sequence number space has been reached or that use of the linear sequence number space has been otherwise disabled, transmit a second plurality of packet in the stream of packets via at least two disjoint paths through the network, wherein (a) each of the second plurality of packets comprises a respective sequence number of a cyclic sequence number space.

In one embodiment, a transmit node for packet or frame replication comprises a network interface and processing circuitry associated with the network interface. The processing circuitry is configured to cause the transmit node to determine that a sequence generation function at the transmit node has been reset. The processing circuitry is further configured to cause the transmit node to, responsive to determining that the sequence generation function at the transmit node has been reset, transmit a first plurality of packets in a stream of packets via at least two disjoint paths through a network, wherein: (a) each of the first plurality of packets comprises a respective sequence number from a linear sequence number space and (b) at least a first packet from among the first plurality of packets that was sent after the reset further comprises an explicit indicator of the reset. The processing circuitry is further configured to cause the transmit node to determine that an end of the linear sequence number space has been reached or that use of the linear sequence number space has been otherwise disabled and, responsive to determining that the end of the linear sequence number space has been reached or that use of the linear sequence number space has been otherwise disabled, transmit a second plurality of packet in the stream of packets via at least two disjoint paths through the network, wherein (a) each of the second plurality of packets comprises a respective sequence number of a cyclic sequence number space.

In one embodiment, a method performed by a transmit node for packet or frame replication comprises obtaining a packet to be sent and determining that the packet does not comprise a tag that indicates that the packet has already been replicated. The method further comprises, responsive to determining that the packet does not comprise a tag that indicates that the packet has already been replicated, determining that a linear sequence number space is to be used and, responsive thereto, enabling an explicit indication in the packet that indicates that the linear sequence number space is being used, adding a sequence number from the linear sequence number space to the packet, and adding a tag to the packet that indicates that the packet has been replicated. The method further comprises providing the packet for replication and transmission.

In one embodiment, the method further comprises, responsive to determining that the packet does not comprise a tag that indicates that the packet has already been replicated, determining that a sequence generation function at the transmit node has been reset, enabling an explicit indication in the packet that indicates that the sequence generation function has been reset responsive to determining that the sequence generation function at the transmit node has been reset, and otherwise disabling the explicit indication in the packet that indicates that the sequence generation function has been reset.

In one embodiment, the method further comprises, responsive to determining that the linear sequence number space is to be used, incrementing the sequence number from the linear sequence number space.

In one embodiment, the method further comprises repeating the method for a plurality of additional packets until the linear sequence number space is exhausted or use of the linear sequence number space is otherwise disabled. In one embodiment, the method further comprises, after the linear number space is exhausted or after use of the linear sequence number space is otherwise disabled, obtaining a further packet to be sent, determining that the further packet does not comprise a tag that indicates that the further packet has already been replicated. The method further comprises, responsive to determining that the further packet does not comprise a tag that indicates that the further packet has already been replicated: determining that a cyclic sequence number space, rather than a linear sequence number space, is to be use; responsive to determining that the cyclic sequence number space is to be used, disabling an explicit indication in the further packet that indicates that the linear sequence number space is being use and adding a sequence number from the cyclic sequence number space to the further packet; and adding a tag to the further packet that indicates that the further packet has been replicated. The method further comprises providing the further packet for replication and transmission.

In one embodiment, the method further comprises, responsive to determining that the further packet does not comprise a tag that indicates that the further packet has already been replicated, determining whether a sequence generation function at the transmit node has been reset, enabling an explicit indication in the further packet that indicates that the sequence generation function has been reset responsive to determining that the sequence generation function at the transmit node has been reset, and otherwise disabling the explicit indication in the further packet that indicates that the sequence generation function has been reset.

Corresponding embodiments of a transmit node are also disclosed. In one embodiment, a transmit node for packet or frame replication is adapted to obtain a packet to be sent and determine that the packet does not comprise a tag that indicates that the packet has already been replicated. The transmit node is further adapted to, responsive to determining that the packet does not comprise a tag that indicates that the packet has already been replicated, determine that a linear sequence number space is to be used. The transmit node is further adapted to, responsive to determining that the linear sequence number space is to be used, enable an explicit indication in the packet that indicates that the linear sequence number space is being used and add a sequence number from the linear sequence number space to the packet. The transmit node is further adapted to add a tag to the packet that indicates that the packet has been replicated and provide the packet for replication and transmission.

In one embodiment, a transmit node for packet or frame replication comprises a network interface and processing circuitry associated with the network interface. The processing circuitry is configured to cause the transmit node to obtain a packet to be sent and determine that the packet does not comprise a tag that indicates that the packet has already been replicated. The processing circuitry is further configured to cause the transmit node to, responsive to determining that the packet does not comprise a tag that indicates that the packet has already been replicated, determine that a linear sequence number space is to be used. The processing circuitry is further configured to cause the transmit node to, responsive to determining that the linear sequence number space is to be used, enable an explicit indication in the packet that indicates that the linear sequence number space is being used and add a sequence number from the linear sequence number space to the packet. The processing circuitry is further configured to cause the transmit node to add a tag to the packet that indicates that the packet has been replicated and provide the packet for replication and transmission.

In one embodiment, a method performed by a receive node for packet or frame elimination comprises receiving a packet from one of a plurality of replicated streams that traverse disjoint paths from a transmit node to the receive node through a network, the packet comprising a sequence number. The method further comprises determining that the packet comprises an explicit indication that a linear sequence number space, rather than a cyclic sequence number space, is being used, determining whether the packet comprises an explicit indication that a sequence generation function at the transmit node has been reset, and determining whether the sequence number of the packet is outside of a reset ignore range (iRIR) associated with use of the linear sequence number space. The method further comprises accepting the packet responsive to determining that the packet comprises the explicit indication that the linear sequence number space is being used and that the packet comprises the explicit indication that the sequence generation function at the transmit nod has been reset and the sequence number of the packet is outside of the iRIR.

In one embodiment, the method further comprises, responsive to determining that the packet comprises the explicit indication that the linear sequence number space is being used and that the packet comprises the explicit indication that the sequence generation function at the transmit node has been reset and the sequence number of the packet is outside of the iRIR, updating a history window and a history associated with the linear sequence number space based on the sequence number of the packet.

In one embodiment, the method further comprises, upon determining that the packet comprises the explicit indication that the linear sequence number space is being used and that the packet either does not comprise the explicit indication that the sequence generation function at the transmit node has been reset or the sequence number of the packet is not outside of the iRIR, determining whether the sequence number of the packet is within a history window (iHSW) associated with the use of the linear sequence number space, determining whether the sequence number of the packet is already in a history associated with the use of the linear sequence number space that comprises sequence numbers from the linear sequence number space that have already been received, and accepting the packet responsive to determining that the sequence number of the packet is within the iHSW and determining that the sequence number of the packet is not already in the history. In one embodiment, the method further comprises discarding the packet responsive to determining that the sequence number of the packet is within the iHSW and determining that the sequence number of the packet is already in the history. In one embodiment, the method further comprises updating the iHSW and the history associated with the linear sequence number space based on the sequence number of the packet responsive to determining that the sequence number of the packet is within the iHSW and determining that the sequence number of the packet is not already in the history.

Corresponding embodiments of a receive node are also disclosed. In one embodiment, a receive node for packet or frame elimination is adapted to receive a packet from one of a plurality of replicated streams that traverse disjoint paths from a transmit node to the receive node through a network, the packet comprising a sequence number. The receive node is further adapted to determine that the packet comprises an explicit indication that a linear sequence number space, rather than a cyclic sequence number space, is being used, determine whether the packet comprises an explicit indication that a sequence generation function at the transmit node has been reset, and determine whether the sequence number of the packet is outside of a reset ignore range (iRIR) associated with use of the linear sequence number space. The receive node is further adapted to accept the packet responsive to determining that the packet comprises the explicit indication that the linear sequence number space is being used and that the packet comprises the explicit indication that the sequence generation function at the transmit node has been reset and the sequence number of the packet is outside of the iRIR.

In one embodiment, a receive node for packet or frame elimination comprises a network interface and processing circuitry associated with the network interface. The processing circuitry is configured to cause the receive node to receive a packet from one of a plurality of replicated streams that traverse disjoint paths from a transmit node to the receive node through a network, the packet comprising a sequence number. The processing circuitry is further configured to cause the receive node to determine that the packet comprises an explicit indication that a linear sequence number space, rather than a cyclic sequence number space, is being used, determine whether the packet comprises an explicit indication that a sequence generation function at the transmit node has been reset, and determine whether the sequence number of the packet is outside of a reset ignore range (iRIR) associated with use of the linear sequence number space. The processing circuitry is further configured to cause the receive node to accept the packet responsive to determining that the packet comprises the explicit indication that the linear sequence number space is being used and that the packet comprises the explicit indication that the sequence generation function at the transmit node has been reset and the sequence number of the packet is outside of the iRIR.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a cloud based scenario requiring improvement of Frame Replication and Elimination for Reliability (FRER) functions;

FIG. 2 illustrates ranges of the IEEE 802.1CB-2017 cyclic sequence number space utilized herein for analysis of probability of packet drop;

FIG. 3 illustrates a system that includes a transmitting (TX) node and a receiving (RX) node that provide FRER in accordance with embodiments of the present disclosure;

FIG. 4 illustrates an example of a relation of a new (linear) sequence number space and the original (cyclic) sequence number space utilized for FRER in accordance with embodiments of the present disclosure;

FIG. 5 illustrates a state diagram for a replication function at the TX node in accordance with one embodiment of the present disclosure;

FIG. 6 is a flow chart that illustrates the operation of the replication function at the TX node in accordance with one embodiment of the present disclosure;

FIG. 7 is a flow chart that illustrates the operation of the replication function at the TX node in accordance with another embodiment of the present disclosure;

FIG. 8 illustrates a state diagram for an elimination function at the RX node in accordance with one embodiment of the present disclosure;

FIGS. 9A and 9B provide a flow chart that illustrates the operation of the elimination function at the RX node according to one embodiment of the present disclosure;

FIG. 10 illustrates the R-TAG format in accordance with IEEE 802.1CB and in which a “SeqResetFlag”, a“InitSeqFlag”, and a “new sequence number belonging to the linear sequence number space” may be encoded in accordance with one embodiment of the present disclosure; and

FIGS. 11, 12, and 13 are schematic block diagrams of a network node.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

TSN Node: As used herein, a Time Sensitive Networking (TSN) node is any network node in a TSN network. Examples of a TSN node include a TSN endpoint and a TSN bridge.

There currently exist certain challenge(s) with respect to TSN and Deterministic Networking (DetNet). The mechanisms available for reset of seamless redundancy functions include too many unnecessary packet drops and are not cloud ready. As the ultimate goal of seamless redundancy is to avoid packet loss as much as possible. The unnecessary packet drops due to the operations of a seamless redundancy mechanism should be minimized. Furthermore, moving seamless redundancy (e.g., Institute for Electronics and Electrical Engineering (IEEE)802.1CB) components to a cloud environment creates challenges regarding availability, so seamless redundancy functions are reset much more frequently than in current industrial hardware environments. Therefore, seamless detection and adaptation to scenarios caused by reset of seamless redundancy (e.g., IEEE 802.1CB) functions are essential.

In addition, the above-described history window and timeout mechanism require good design of related parameters. However, these are not trivial tasks as contradicting requirements must be fulfilled. During the history window design, one may intend to select a small window size, for example, in order to protect the Elimination node resources or to protect against bogus packets (security). In contrast, large window size values are more tolerant to network failures and errors. It may be a hard task to find an optimum window size. Similarly, designing a too low timeout parameter value may cause frequent (and unnecessary) reset of the Elimination function. On the other hand, a too large timeout parameter value slows down the recovery after failure scenarios and causes unwanted networking transient. Furthermore, using Frame Replication and Elimination for Reliability (FRER) for bursty (non-Constant Bit Rate (CBR)) streams makes the above design more challenging or even impossible to find a right balance.

In our former PCT Patent Application International Publication No. WO2021005397A1 (hereinafter referred to as “the '397 Application”), an explicit notification solution is described that is based on a new flag included in the R-TAG, namely the “SeqResetFlag”. This flag is set by the Replication function when the sequence generation function was reset, so such events can be recognized easily by the Elimination functions. With this solution, the focus is on the scenario where frames might be dropped unnecessarily (with a high probability) when the sequence generation function was reset. This solution provides a much better solution than IEEE 802.1CB-2017 when the sequence generation function was reset, but it cannot provide fully lossless recovery in all cases. It may result in some dropped packets after the reset event.

Certain aspects of the present disclosure and their embodiments may provide solutions to the aforementioned or other challenges. Systems and methods are described herein that provide seamless recovery for sequence number based seamless redundancy mechanisms after a sequence number generation reset event.

Embodiments of the solution proposed herein target solving the scenario where frames are dropped unnecessarily by IEEE 802.1CB-2017 functions due to the reset of the sequence generation function.

Aspects of the proposed solution include:
1. an explicit notification of the reset event, and
2. adding a new linear initial sequence number space to the existing cyclic sequence number space of IEEE 802.1CB-2017.
   Note that the existing cyclic sequence number space of IEEE 802.1CB-2017 is referred to in this document as the “original sequence number space”.

Explicit notification of the reset event is based on a flag included in the R-TAG, which is referred to herein as the “SeqResetFlag”. The usage of the new linear initial sequence number space (which is referred to herein as “InitSeqNumSpace”) is noted via a new flag included in the R-TAG, which is referred to herein as the “InitSeqFlag”. Sequence values of the new number space (“InitSeqNumSpace”) are also included in the R-TAG.

While the embodiments described herein focus on FRER of TSN, the solutions proposed herein are also applicable to PREF of DetNet or other seamless redundancy mechanisms based on sequence numbering or equivalent functionality (e.g., provided by timestamps).

Embodiments of the solution described herein enable cloudification of seamless redundancy by providing seamless reset for sequence number generation (Sequence generating function) via improvements of, e.g., the Replication and Elimination function of IEEE 802.1CB-2017. In some embodiments, the following aspects are introduced (1) a new flag for explicit indication of the Sequence generating function reset and (2) the use of a new linear initial sequence number space to the existing cyclic sequence number space of, e.g., IEEE 802.1CB-2017. Again, while the description provided herein focuses on FRER as defined in IEEE 802.1CB, the solution described herein is applicable to FRER of TSN, PREF of DetNet, or other seamless redundancy mechanisms based on sequence numbering or equivalent functionality (e.g., provided by timestamps).

There are, proposed herein, various embodiments which address one or more of the issues disclosed herein. Certain embodiments may provide one or more of the following technical advantage(s). Embodiments of the proposed solution described herein enable cloudification of seamless redundancy by providing seamless reset for sequence number generation (Sequence generating function) via improvements of the Replication and Elimination function of IEEE 802.1CB-2017. These improvements ensure much faster and seamless adaptation to network failure scenarios and protect again unnecessary packet drops when sequence generation is reset.

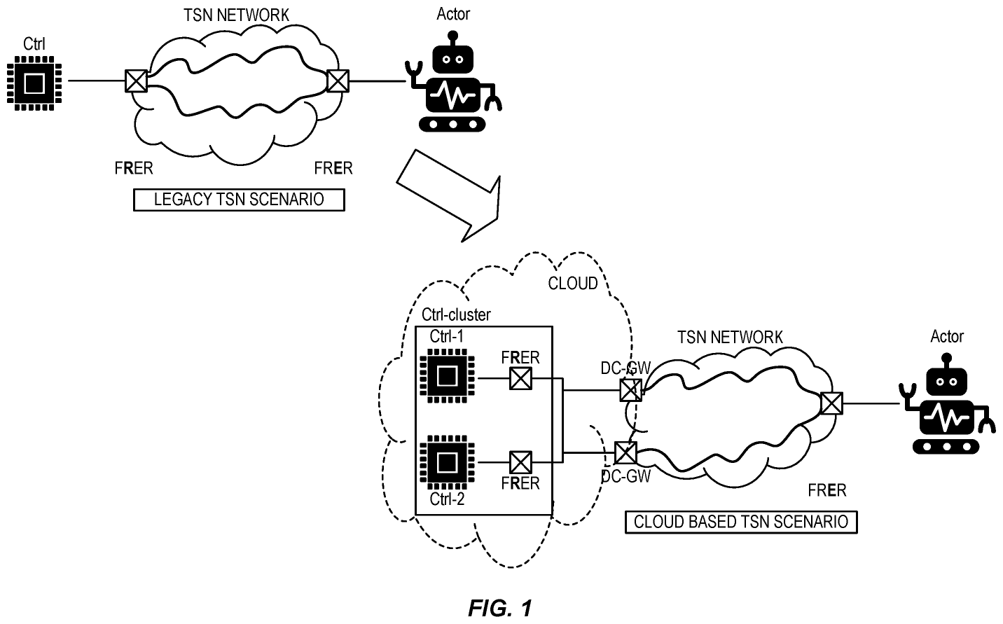

The main motivation for these improvements is to allow cloudification, i.e., “cloud native” implementation of FRER/Packet Replication and Elimination Function (PREF) functions. Today's trend is to move applications towards virtualized environments. This trend has reached applications used in industrial environments as well, see, e.g., edge computing, fog computing. Using FRER/PREF in a cloud-based scenario, where Talkers/Listeners (Sources/Destinations) are moved to the Cloud, creates many additional challenges for the FRER/PREF functions. FRERs/PREFs are TSN/DetNet functions that belong to the endpoints, so FRER/PREF must work inside the Cloud. For example, a FRER/PREF is usually an instance in a controller-cluster (ctrl-cluster) serving an industrial application in a cloud, as illustrated in FIG. 1. In this regard, FIG. 1 illustrates a Cloud based scenario requiring improvement of FRER functions.

Typical Cloud actions like running multiple Virtual Machines (VMs)/containers/instances, creating a VM/container/instance, moving a VM/container/instance, resetting a function, removing a VM/container/instance, etc. require FRER functions to adapt to the changing environment seamlessly. Changes in this environment are much more frequent than in current industrial network scenarios or network deployments without cloud.

High availability systems require the elimination of any single point of failure. Therefore, FRER/PREF functions (i.e., Sequence generation) must be improved to be able to support various Cloud specific redundancy solutions.

Using FRER of IEEE 802.1CB as an example, the impact of the reset of the sequence number generation function depends on the actual value of the sequence_number used for the last packet sent before the reset (noted here as SN_{L}) and the value of the sequence_number used for the first packet sent after the reset (noted here as SN_{R}). According to IEEE 802.1CB-2017, SN_{R} is always 0 and SN_{L} is a value in the range of {0; . . . ; GenSeqSpace−1}.

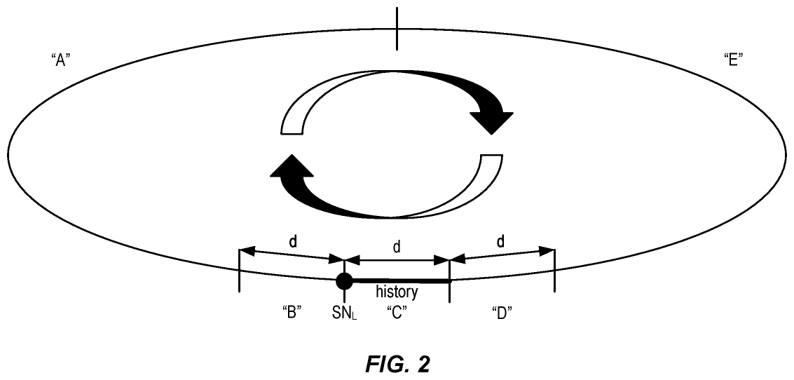

The following ranges can be defined to analyze the impact of the reset for (1) the solution described in IEEE 802.1CB-2017, (2) the solution described in the '397 Application, and (3) the solution described herein.
A: SN_{R}>SN_{L}+d
B: SN_{L}+d>=SN_{R}>SN_{L}
C: SN_{L}>=SN_{R}>SN_{L}−d
D: SN_{L}−d>=SN_{R}>SN_{L}−2d
E: SN_{L}−2d>=SN_{R}
   where d=“frerSeqRcvyHistoryLength” defined in IEEE 802.1CB-2017. Note that due to the cyclic characteristic of the original sequence number space, “A” and “E” are adjacent ranges, where the border between them is be defined here for the analysis as modulo_{GenSeqSpace}(SN_{L}+GenSeqSpace/2). FIG. 2 illustrates the ranges of the cyclic sequence number space.

The assumption for the analysis is that (i) there are no other events in the network, only the sequence generation function is reset and (ii) the “frerSeqRcvyHistoryLength” (d) takes value of 100 for the probability calculations.

For the evaluation of the solution described in IEEE 802.1CB-2017, the following range is important:
history window (HSW)={SN_{L}+d; . . . ; SN_{L}−d+1}, where d=“frerSeqRcvyHistoryLength”.
   Note that HSW is practically the merger of range “B” and range “C” used for the evaluation.

As per IEEE 802.1CB-2017, packets with a sequence_number out of the history window (HSW) are dropped and packets within the history window are evaluated against the “SequenceHistory” to decide whether or not they are duplicates. Therefore, IEEE 802.1CB-2017 operates as follows for each of the ranges A-E:
A: packets are dropped until timer expires or the sequence_number of packets reaches SN_{L}+1,
B: no packet drop, SN_{R} is accepted,
C: packets are dropped until sequence_number of packets reaches SN_{L}+1,
D: packets are dropped until sequence_number of packets reaches SN_{L}+1,
E: packets are dropped until timer expires or the sequence_number of packets reaches SN_{L}+1.
   That is, there is high probability of packet drop (99.8%) in most cases until timeout triggers the accept of the next packet. Note that packet drop means packet loss for the application whose operation may be damaged by the lost packets.

For the evaluation of the solution described in the '397 Application, the following additional range is important:
reset ignore range (RIR)={SN_{L}+d; . . . ; SN_{L}−2d+1}, where d=“frerSeqRcvyHistoryLength”
   Note that RIR is practically the merger of range “B”, range “C”, and range “D” used for the evaluation.

RIR is the range where the Eliminator function ignores the received “SeqResetFlag” and checks the received packet against the HSW. Note that range “D” is also part of RIR, as duplicates over the slower redundancy paths may have a sequence_number below SN_{L} and can be as low as SN_{L}−d. Therefore, the solution described in the '397 Application behaves as follows for each of the ranges:

A: no packet drop, SN_{R} accepted,

B: no packets drop, SN_{R} accepted,

C: packet drop until sequence_number of packets reaches SN_{L}+1,

D: packet drop until sequence_number of packets reaches SN_{L}+1,

E: no packet drop, SN_{R} accepted.

There is a low probability of packet drop (0.3%) in most cases. When packet drop does happen, it is limited to a maximum of “2d” number of packets after the reset. Some TSN applications may tolerate this when reset occurs, some may not.

The solution described herein has the following characteristics for each of the ranges:

A: no packet drop, SN_{R} accepted,

B: no packet drop, SN_{R} accepted,

C: no packet drop, SN_{R} accepted,

D: no packet drop, SN_{R} accepted,

E: no packet drop, SN_{R} accepted.

There is no packet drop. Packets sent after the reset are immediately considered valid. TSN applications are not impacted at all, and the implementation impact on FRER nodes is moderate.

Systems and methods are disclosed herein for improving the elimination function in a TSN network using FRER in accordance with IEEE 802.1CB (or likewise in a DetNet network using PREFs. Note that the discussion herein uses IEEE 802.1CB terminology and variable names where appropriate, denoted as “VariableName”. New variables, functions, and parameters follow IEEE 802.1CB naming conventions and are denoted as “NewEntityName”.

From now on, the description focuses on embodiments of the proposed solution for IEEE 802.11 FRER and as such uses terms and notations as described in 802.1CB-2017 FRER. However, the solution proposed herein is equally applicable to other seamless redundancy mechanisms (e.g., PREF for DetNet) based on sequence numbering or equivalent functionality (e.g., provides by timestamps).

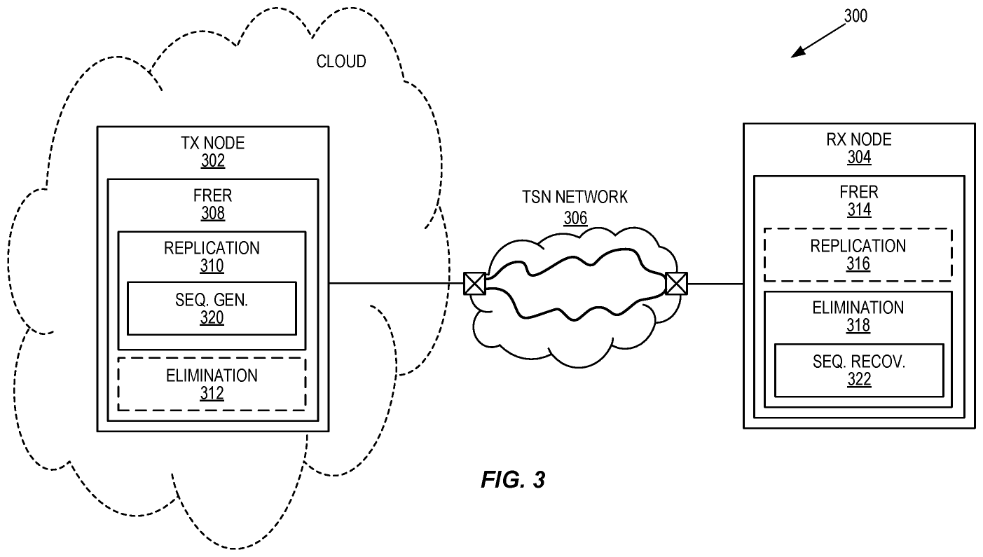

FIG. 3 illustrates a system 300 that includes a transmitting (TX) node 302 and a receiving (RX) node 304 where the TX node 302 transmits a replicated stream of packets to the RX node 304 via a TSN network 306. Note that the TX node 302 and RX node 304 may be, for example, TSN endpoints, TSN bridges, or any other type of TSN node, in this example. Transmission of the replicated stream of packets involves replicating a Stream of packets into multiple Member Streams to thereby provide a Compound Stream. The Member Streams are then transmitted to the RX node 304 via the TSN network 306 via maximally disjoint paths. Note that while the nodes 302 and 304 are denoted herein as “TX node” and “RX node”, respectively, it should be understood that these nodes may both transmit and receive streams via the TSN network 306.

As illustrated, the TX node 302 includes a FRER function 308 that operates to provide FRER in accordance with, in this example, IEEE 802.1CB. The FRER 308 includes a Replication function 310 and an Elimination function 312 (illustrated as optional in the sense that it is not used for transmission of the Stream to the RX node 304). In a similar manner, the RX node 304 includes a FRER function 314 that operates to provide FRER in accordance with, in this example, IEEE 802.1CB. The FRER 314 includes a Replication function 316 (illustrated as optional in the sense that it is not used for reception of the Stream from the TX node 302) and an Elimination function 322.

As illustrated, the Replication function 310 includes a Sequence Generation function 320. The Sequence Generation function 320 operates to generate sequence numbers for the packets in the packet Stream. The Elimination function 318 includes a Sequence Recovery function 322. The Sequence Recovery function 322 operates on packets passed up the protocol stack towards the higher layer functions and uses the sequence number sub-parameter to decide which packets to pass and which to discard.

In some embodiments, the TX node 302 is part of a Cloud implementation (e.g., part of a Ctrl-cluster as described above with respect to FIG. 1).

A Sequencing function of the FRERs 308 and 314 provides the “sequence_number” sub-parameter for FRER functions. In particular, the Sequencing function has two kinds of component functions: (1) a Sequence Generation function (e.g., the Sequence Generation function 320) that operate on packets passed down the protocol stack towards the physical layer and generates a value for the sequence_number sub-parameter and (2) a Sequence Recovery function (e.g., the Sequence Recovery function 322) that operates on packets passed up the protocol stack towards the higher layer functions and uses the sequence_number sub-parameter of the received packets to decide which packets to pass and which to discard.

Embodiments of the solution described herein use the flag introduced by the '379 Application to the R-TAG, namely the “SeqResetFlag”. This flag is used as follows:
When transmitting the Stream of packets, the Replication function 310 at the TX node 302 does not change the “SeqResetFlag” value of the packet if a Redundancy Tag (R-TAG) is already included in the header of the packet (i.e., in the header of the corresponding Ethernet frame).
The Replication function 310 at the TX node 302 sets the “SeqResetFlag” (e.g., sets the “SeqResetFlag” value=1) for a given time period or for a number of sent packets when the Sequence Generation function 320 is reset.
The Replication function 310 at the TX node 302 clears the “SeqResetFlag” (e.g., sets the “SeqResetFlag” value=0) in all other cases.

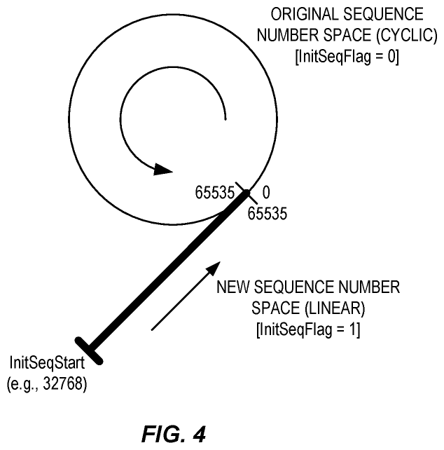

Embodiments of the solution described herein introduce a new additional sequence number space, which is referred to herein as “InitSeqNumSpace”, which is used after initialization or reset of the Sequence Generation function 320. The newly introduced InitSeqNumSpace is illustrated by the bolded linear sequence number space in FIG. 4. The sequence_number of the next packet is stored in a new variable, namely the “InitGenSeqNun”. When this new number space is exhausted, the Sequence Generation function 320 starts to use the original sequence number space, which is illustrated by the non-bolded sequence number space in FIG. 4. In other words, FIG. 4 illustrates an example of the relation of the new (linear) sequence number space and the original (cyclic) sequence number space.

Embodiments of the solution described herein introduce a new flag in the R-TAG, which is referred to as the “InitSeqFlag”. This flag is used by the Replication function 310 at the TX node 302 as follows:
For each packet in the Stream of packets being transmitted by the TX node 302, the Replication function 310 does not change the “InitSeqFlag” value of the packet if R-TAG is already included in the header of the packet.
The Replication function 310 sets the “InitSeqFlag” (e.g., sets the “InitSeqFlag” value=1) when the Sequence Generation function 320 is initialized or reset. The “InitSeqNumSpace” is used by the Replication function 310 to generate the sequence number for the packet.
The Replication function 310 clears the “InitSeqFlag” (e.g., sets the “InitSeqFlag” value=0) in all other cases.

The “InitSeqNumSpace” is used as follows:
“InitSeqNumSpace” is a linear sequence number space starting with “InitSeqStart” (e.g., a configurable parameter set to, in the example of FIG. 4) 32768 and ends with “GenSeqSpace-1” (i.e., 65535 as per IEEE 802.1CB-2017).
“InitSeqAlumSpace” has its own set of variables that are used to deal with the sequence_number of packets. Note that the InitSeqAlumSpace variable names are derived from the variable names of the original sequence number via appending them with an “Init” prefix, e.g., “InitGenSeqNum”, “InitRecovSeqNum”, “InitSequenceHistory”, “InitTakeAny”, “InitRemainingTicks”, etc.
The Replication function 310 at the TX node 302 uses the “InitSeqAlumSpace” as follows:
   “UseInitSeqSpace” is a Boolean state variable showing that the new “InitSeqAlumSpace” (value=1) has to be used by Sequence Generation function 320 to generate the sequence_number for the next packet.
   Whenever the Sequence Generation function 320 is initialized or reset, “UseInitSeqSpace” is set (e.g., value=1) to show that “InitSeqAlumSpace” must be used to generate the sequence_number for sent packets.
   All packets sent with sequence_number from “InitSeqAlumSpace” have in their R-Tag the “InitSeqFlag” set (e.g., value=1).
   “InitGenSeqAlum” takes the value of “InitSeqStart” whenever the Sequence Generation function 320 is initialized or reset, and incremented by 1 when a packet is sent.
   When “InitGenSeqAlum” is incremented and becomes greater than its maximum value, “UseInitSeqSpace” is cleared (e.g., value=0) to show that “InitSeqAlumSpace” cannot be used. The Sequence Generation function 320 then uses the original sequence number space for the next packet.
   If “UseInitSeqSpace” is clear (value=0), the Sequence Generation function 320 uses “GenSeqNum” to generate the sequence_number of the next packets (i.e., the original sequence number space is used).

Embodiments of the solution herein define a new procedure for the Elimination function 318 at the RX node 304 as well. It uses the new set of variables to handle packets containing sequence_number from the above described “InitSeqAlumSpace”. The size of the history window is same for both sequence number spaces. The Elimination function 318 operates as follows upon receiving a packet from one of the Member Streams of the Stream transmitted by TX node 302:
If the “InitSeqFlag” flag in the received packet is set (e.g., value=1), the Sequence Recovery function 322 uses the new linear sequence number space (InitSeqAlumSpace) related variables the following way:
   The Sequence Recovery function 322 sets “InitRecovSeqAlum” to the “sequence_number” of the packet and clears the “InitSequenceHistory”, if the “SeqResetFlag” is set and “sequence_number” of the packet is out of the iRIR range {“InitRecovSeqAlum”+“frerSeqRcvyHistoryLength”; . . . ; “InitRecovSeqAlum”−2×“frerSeqRcvyHistoryLength”+1}. Note that the range has to be calculated according to the borders of the new linear sequence number space.
   The Sequence Recovery function 322 ignores the “SeqResetFlag” if the “sequence_number” of the packet is within the iRIR range. If the “sequence_number” is out of the iHSW range {“InitRecovSeqAlum”+“frerSeqRcvyHistoryLength”; . . . ; “InitRecovSeqNum”−“frerSeqRcvyHistoryLength”+1} packet is dropped. If it is within iHSW, then it is checked whether or not the packet has been already received.
   The Sequence Recovery function 322 does not change the “SeqResetFlag” and “InitSeqFlag” value of the packet.
   The Sequence Recovery function 322 sets the “TakeAny” variable of the original sequence number space if the “sequence_number” of the packet is in the following range {“GenSeqSpace”−“frerSeqRcvyHistoryLength”; . . . ; “GenSeqSpace”−2×“frerSeqRcvyHistoryLength” }. Note that this range shows that the new initial sequence number space is soon exhausted, i.e., approaching the original sequence number space.
If the “InitSeqFlag” flag in the received packet is clear (value=0), the sequence recovery function uses the original sequence number space related variables.
   The Sequence Recovery function 322 sets the “RecovSeqNum” to the value of the “sequence_number” of the packet and clears the “SequenceHistory” if the “SeqResetFlag” is set and the “sequence_number” of the packet is out of the RIR range {“RecovSeqNum”+“frerSeqRcvyHistoryLength”; . . . ; “RecovSeqNum”−2×“frerSeqRcvyHistoryLength”+1}. Note that the range has to be calculated according to the modulo rules of the original sequence number space.
   The Sequence Recovery function 322 ignores the “SeqResetFlag” if the “sequence_number” of the packet is within the RIR range. If the “sequence_number” is out of the HSW range, packet is dropped. If it is within HSW, then checked whether or not the packet has been already received.
   The Sequence Recovery function 322 does not change the “SeqResetFlag” value of the packet.

Note that the timeout mechanism for the sequence recovery—to accept the next packet, no matter what the value of its sequence_number subparameter (see “TakeAny” variable in 802.1CB-2017 for the original sequence number space)—is not changed and applied for both sequence number spaces.

An implementation may use two variables to enable/disable the use of the reset flag (“UsingResetFlag”=1/0 (enable/disable)) and the new initial sequence number space (“UsingInitSpace”=1/0 (enable/disable)).

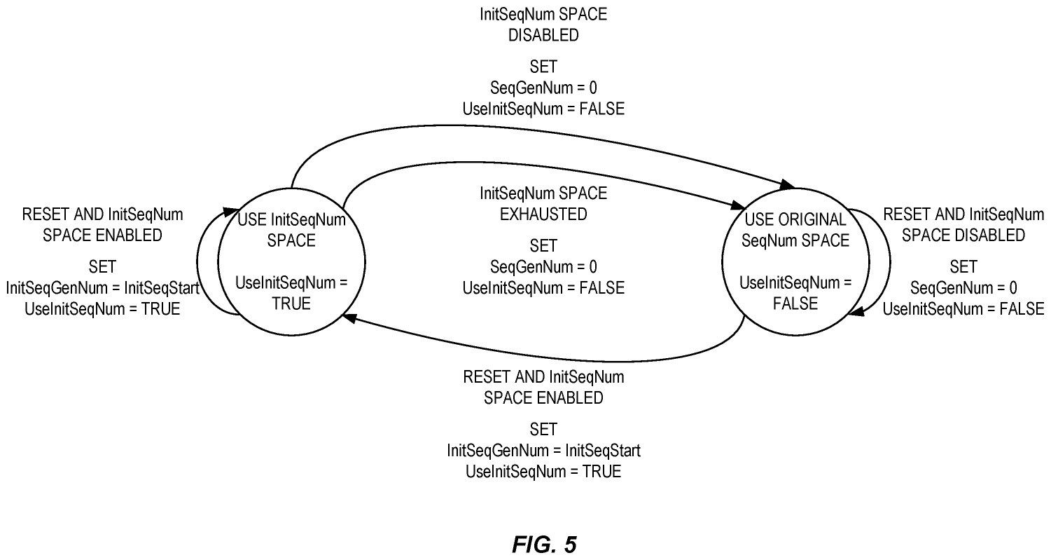

FIG. 5 illustrates a state diagram for the Replication function 310 at the TX node 302 in accordance with one embodiment of the present disclosure. As illustrated, when in a first state in which the Replication function 310 uses the original sequence number space and UsingInitSpace=False, the Replication function 310 uses the original sequence number space. Upon reset with the initial sequence number space disabled, the Replication function 312 sets SeqGenNum=0 and UseInitSeqNum=False and remains in the first state. However, upon reset with the initial sequence number space enabled, the Replication function 310 sets InitSeqGenNum=InitSeqStart and UseInitSeqNum=True and transitions to a second state in which the Replication function 310 uses the initial sequence number space. While in the second state, upon reset with the initial sequence number space enabled, the Replication function 310 sets InitSeqGenNum=InitSeqStart and UseInitSeqNum=True and remains in the second state in which the Replication function 310 uses the initial sequence number space. While in the second state, upon exhausting the initial sequence number space, the Replication function sets SeqGenNum=0 and UseInitSeqNum=False and transitions to the first state in which the Replication function uses the original sequence number space. While in the second state, upon the initial sequence number space being disabled, the Replication function sets SeqGenNum=0 and UseInitSeqNum=False and transitions to the first state in which the Replication function uses the original sequence number space.

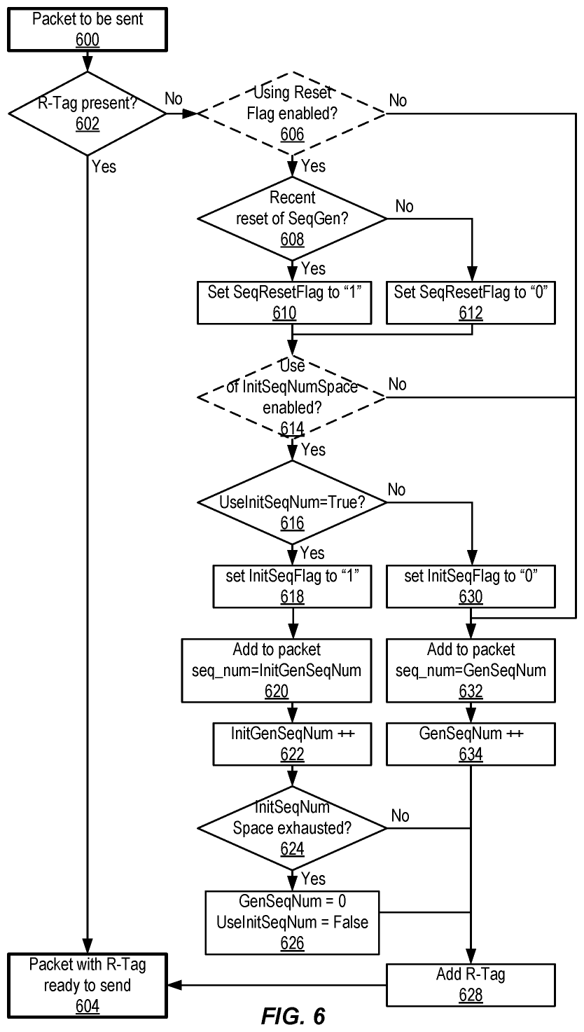

FIG. 6 is a flow chart that illustrates the operation of the Replication function 310 at the TX node 302 in accordance with one embodiment of the present disclosure. Optional steps are represented with dashed lines. As illustrated, the Replication function 310 receives a packet (e.g., from a higher layer(s) in the protocol stack) to be sent (step 600). The Replication function 310 determines whether the R-Tag is present or set in the packet (step 602). If so (602, YES), the packet with the R-Tag set is ready to be sent, and as such provided to a lower layer in the protocol stack for transmission (step 604). For instance, multiple copies of the packet may then be generated and sent via different (e.g., disjoint) paths through the TSN network 306. If the R-Tag is not present or set in the packet (step 602, NO), the Replication function 310 determines whether the “UsingResetFlag” is enabled (step 606). If so, the Replication function 310 determines whether the Sequence Generation function 320 has recently been reset (step 608). This is true if a reset has occurred within a predefined or preconfigured amount of time prior to receiving the packet (i.e., the current time) or within a predefined or preconfigured number of packets prior to the receiving the packet. If the Sequence Generation function 320 has recently been reset (step 608, YES), the Replication function 310 enables the “SeqResetFlag” (e.g., set it to a value of “1”) (step 610). Otherwise, the Replication function 310 disables the “SeqResetFlag” (e.g., sets it to a value of “0”) (step 612).

Whether proceeding from step 610 or step 612, the Replication function 310 determines whether use of “InitSeqNumSpace” is enabled (step 614). If not (614, NO), the process proceeds to step 632, which is described below. Otherwise (step 614, YES), the Replication function 310 determines whether “UseInitSeqNum” is enabled (e.g., set to “True”) (step 616). If so (step 616, YES), the Replication function 310 enables “InitSeqFlag” (e.g., sets it to “1”) (step 618), adds a sequence number (seq_num) equal to “InitGenSeqNum” to the packet (step 620), increments “InitGenSeqNum” (step 622), and determines whether the “InitSeqNumSpace” is exhausted (step 624). If not (step 624, NO), the process proceeds to step 628, which is described below. Otherwise (step 624, YES), the Replication function 310 sets “GenSeqNum” equal to “0” and sets “UseInitSeqNum” to False (step 626). Then, whether proceeding from the “NO” branch of step 624 or step 626, the Replication function 310 adds an R-Tag to the packet (step 628) and the procedure proceeds to step 604 where the packet is ready to send.

Returning to step 616, if “UseInitSeqNum” is not set to “TRUE”, the Replication function 310 disables the “initSeqFlag” (e.g., sets it to “0”) (step 630), adds a sequence number (seq_num) equal to “GenSeqNum” to the packet (step 632), and increments “GenSeqSum” (step 634). The procedure then proceeds to step 628 where an R-Tag is added to the packet and then the packet is ready to be sent.

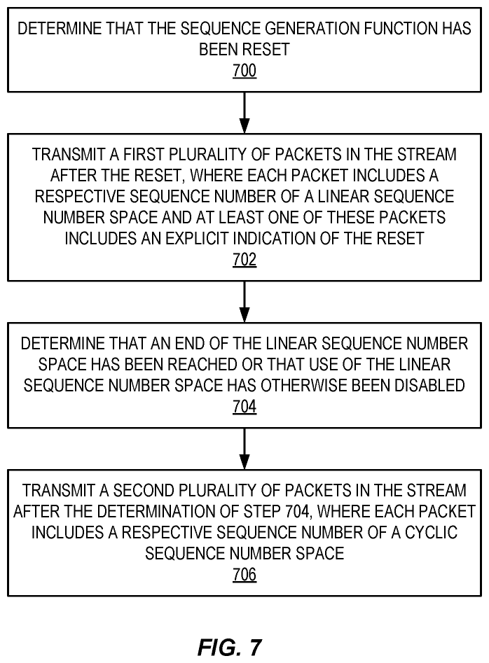

FIG. 7 is a flow chart that illustrates the operation of the Replication function 310 at the TX node 302 in accordance with another embodiment of the present disclosure. This embodiment is similar to that of FIG. 6. As illustrated, the Replication function 310 determines that the sequence generation function 310 at the TX node 302 has been reset (step 700). Responsive to determining that the sequence generation function 310 at the TX node 302 has been reset, the Replication function 310 transmits a first plurality of packets in a Stream of packets, wherein: (a) each of the first plurality of packets comprises a respective sequence number from a linear sequence number space and (b) at least a first packet from among the first plurality of packets that was sent after the rest further comprises an explicit indicator of the reset (step 702). The Replication function 310 determines that an end of the linear sequence number space has been reached or that use of the linear sequence number space has been otherwise disabled (step 704). Responsive to determining that the end of the linear sequence number space has been reached or that use of the linear sequence number space has been otherwise disabled, the Replication function 310 transmits a second plurality of packet in the Stream of packets, wherein (a) each of the second plurality of packets comprises a respective sequence number of a cyclic sequence number space (step 706).

In one embodiment, each of the first plurality of packets further comprises an explicit indication that the linear sequence number space is being used.

In one embodiment, the network is a TSN network. Further, in one embodiment, the method further comprises resetting the sequence generation function 310, wherein resetting the sequence generation function 310 comprises resetting a sequence number history, a history window (e.g., resetting “RecovSeqNum”, which is the midpoint of the history window), or both the sequence number history and the history window. In one embodiment, the steps of determining (700) that the sequence generation function 310 at the TX node 302 has been reset, transmitting (702) the first plurality of packets in the Stream of packets, determining (704) that the end of the linear sequence number space has been reached or that use of the linear sequence number space has been otherwise disabled, and transmitting (706) the second plurality of packet in the Stream of packets are performed by the FRER function 308 of the TX node 302 and, more specifically, by the Replication function 310 of the TX node 302.

In another embodiment, the network is a DetNet network. Further, in one embodiment, the steps of determining (700) that the sequence generation function 310 at the TX node 302 has been reset, transmitting (702) the first plurality of packets in the Stream of packets, determining (704) that the end of the linear sequence number space has been reached or that use of the linear sequence number space has been otherwise disabled, and transmitting (706) the second plurality of packet in the Stream of packets are performed by a PRER of the TX node 302.

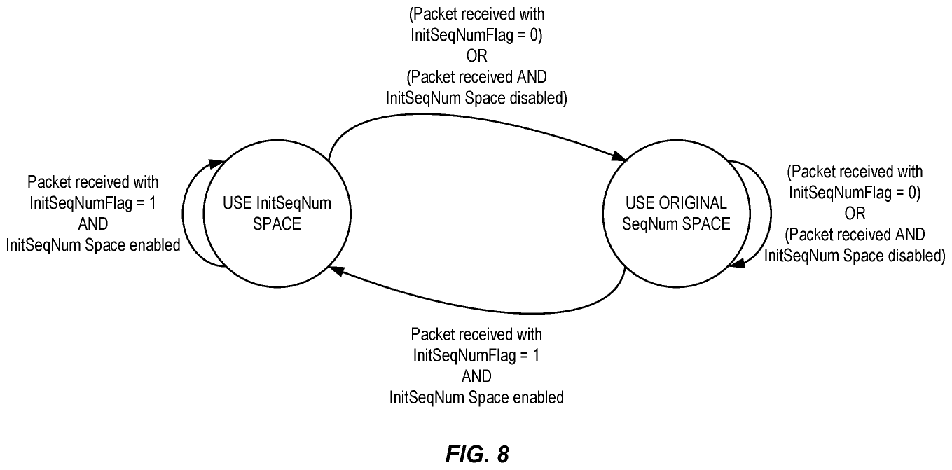

FIG. 8 illustrates a state diagram for an example embodiment of the Elimination function 318 at the RX node 304. As illustrated, when in a first state, the Elimination function 318 uses the original sequence number space. When in the first packet state and a packet is received with InitSeqNumFlag=0 or a packet is received and the initial sequence number space is disabled, the Elimination function 318 remains in the first state. However, when in the first state and a packet is received with InitSeqNumFlag=1 and the initial sequence number space enabled, the Elimination function 318 transitions to a second state in which the Elimination function 318 uses the initial sequence number space. When in the second state and a packet is received with InitSeqNumFlag=1 and the initial number sequence is enabled, the Elimination function 318 remains in the second state. When in the second state and a packet is received with InitSeqNumFlag=0 or a packet is received and initial sequence number space is disabled, the Elimination function 318 transitions to the first state.

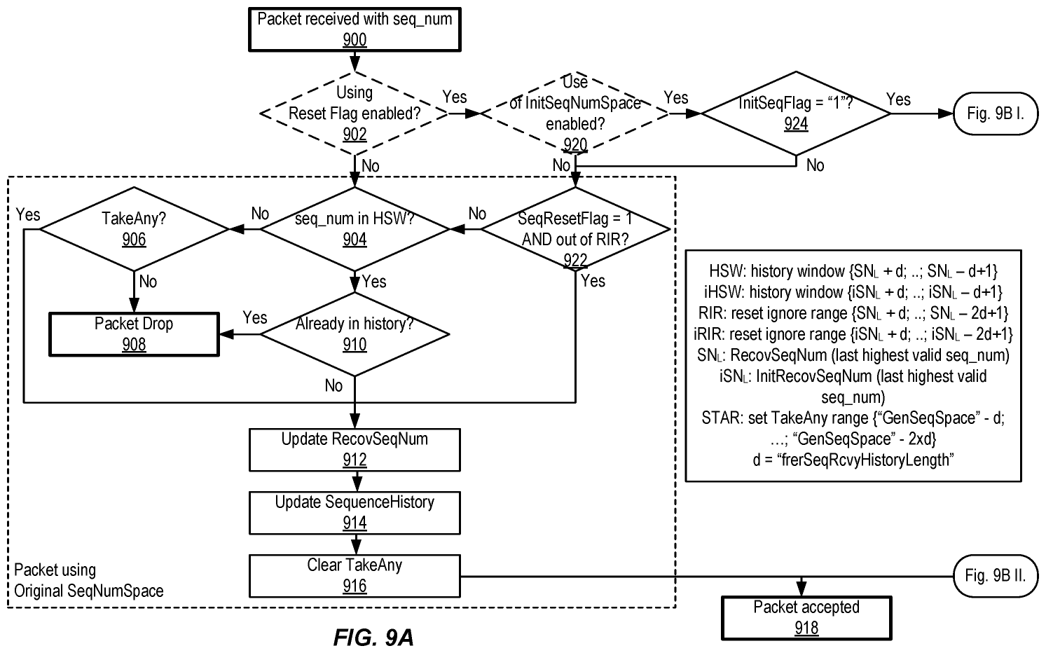

FIGS. 9A and 9B provide a flow chart that illustrates the operation of the Elimination function 318 at the RX node 304 according to one embodiment of the present disclosure. Optional steps are represented with dashed lines. As illustrated, the Elimination function 318 receives a packet (e.g., from a lower layer(s) in the protocol stack) to be processed (step 900). The packet has a “seq_num” value. The Elimination function 318 determines whether the “UsingResetFlag” is enabled (step 902). If not (step 902, NO), the Elimination function 318 determines whether the sequence number of the packet is in the history window (HSW) (step 904). If not (step 904, NO), the Elimination function 318 determines whether “TakeAny” is enabled (step 904). If not (step 906, NO), the Elimination function 318 drops the packet (step 908). Otherwise, if “TakeAny” is enabled (step 906, YES), the procedure proceeds to step 912, which is described below. Returning to step 904, if the sequence number of the packet is in the HSW (step 904, YES), the Elimination function 318 determines whether the sequence number of the packet is already in the history (step 910). If so (step 910, YES), the Elimination function 318 drops the packet (step 908). Otherwise, if the sequence number of the packet not already in the history (step 910, NO), the procedure proceeds to step 912, which is described below.

Returning to step 902, if “UsingResetFlag” is enabled (step 902, YES), the Elimination function 318 determines whether use of “InitSeqNumSpace” is enabled (step 920). If not (step 920, NO), the Elimination function 318 determines whether “SeqResetFlag” is enabled and the sequence number of the received packet is out of the RIR (step 922). If not (step 922, NO), the procedure proceeds to step 904. Otherwise (step 922, YES), the procedure proceeds to step 912.

Whether proceeding from the YES branch of step 906, the NO branch of step 910, or the YES branch of step 922, the Elimination function 318 then updates the “RecovSeqNum” (step 912), updates the “SequenceHistory” (step 914), clears “TakeAny” (step 916), and accepts the packet (step 918).

Returning to step 920, if use of “InitSeqNumSpace” is enabled (step 920, YES), the Elimination function 318 determines whether “InitSeqFlag” is enabled (step 924). If not (step 924, NO), the process proceeds to step 922. Otherwise (step 924, YES), the Elimination function 318 determines whether “SeqResetFlag” is enabled and the sequence number of the received packet is out of iRIR (step 926). If so (step 926, YES), the procedure proceeds to step 932, which is described below. Otherwise (step 926, NO), the Elimination function 318 determines whether the sequence number of the packet is in iHSW (step 928). If so (step 928, YES), the Elimination function 318 determines whether the packet is already in history (step 930). If no (step 930), the procedure proceeds to step 932. Otherwise (step 932, NO), the Elimination function 318 drops the packet (step 944). Returning to step 928, if the sequence number of the packet is not in iHSW (step 928, NO), the Elimination function 318 determines whether “InitTakeAny” is enabled (step 942). If not (step 942, NO), the Elimination function 318 discards the packet (step 944). Otherwise (step 942, YES), the process proceeds to step 932.

Whether proceeding from the YES branch of step 926, the NO branch of step 930, or the YES branch of step 942, the Elimination function 318 updates the “InitRecovSeqNum” (step 932), updates “InitSequenceHistory” (step 934), and clears “InitTakeAny” (step 936). The Elimination function 318 determines whether the sequence number is in STAR (i.e., the range {“GenSeqSpace”−d; . . . ; “GenSeqSpace”−2×d}) (step 938). If so (step 938, YES), the Elimination function 318 sets “TakeAny” to TRUE (step 940) and the packet is accepted (step 918). Otherwise (step 938, NO), the Elimination function 318 accepts the packet (step 918).

One possible option to encode the “SeqResetFlag”, the “InitSeqFlag”, and the “new sequence number belonging to the linear sequence number space” in the R-TAG are described in the following:

in the reserved field (2^{nd} and 3^{rd} bytes of the R-TAG), and/or

in the Sequence Number field (4^{th} and 5^{th} bytes of the R-TAG).

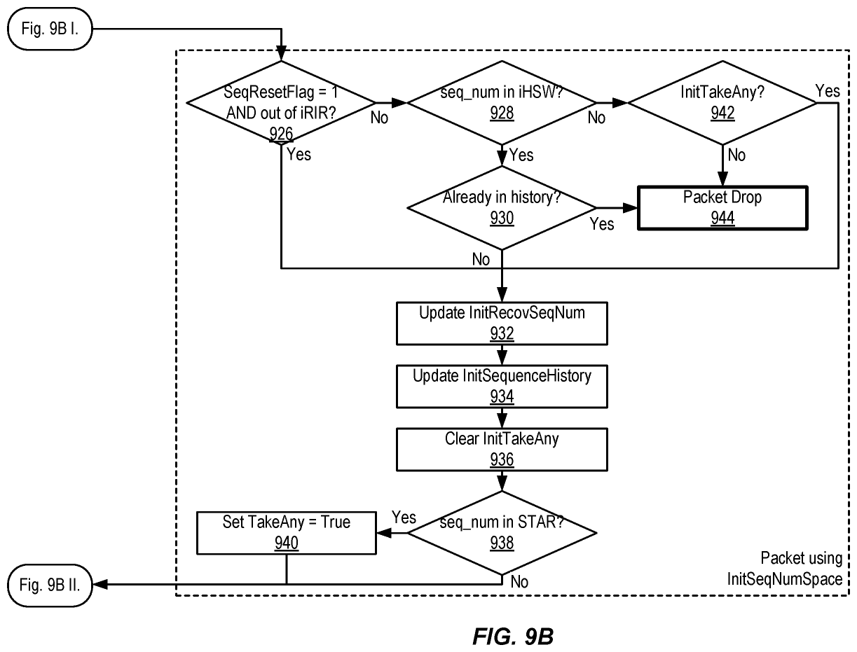

In FIG. 10, which illustrates the R-TAG format (FIG. 7-4 in IEEE 802.1CB):
“SeqResetFlag” and “InitSeqFlag” can be encoded in the R-TAG using 2 bits of the reserved field, one bit for each flag. As per 802.1CB-2017: “This field shall be transmitted with all zeros and shall be ignored on receipt.” The “new sequence number belonging to the linear sequence number space” can be encoded in the Sequence Number field of the R-TAG. “InitSeqFlag” indicates how to interpret the Sequence Number field.
   Other encoding methods can be constructed as well. For example, “SeqResetFlag” can be encoded in the R-TAG using the reserved fields using 1 bit, and the “new sequence number belonging to the linear sequence number space” can be encoded in the remaining 15 bits of the reserved fields. Such an encoding includes the information of the sequence number space as well, so no need to explicitly encode the “InitSeqFlag”.

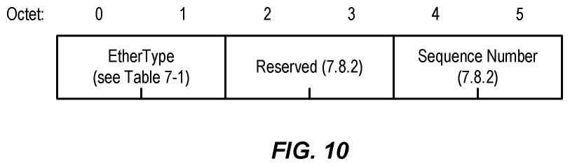

FIG. 11 is a schematic block diagram of a network node 1100 according to some embodiments of the present disclosure. The network node 1100 may be the TX node 302 or the RX node 304 described above. As illustrated, the network node 1100 includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. The one or more processors 1104 operate to provide one or more functions of the network node 1100 as described herein (e.g., one or more functions of the TX node 302 or one or more functions of the RX node 304, as described herein). In some embodiments, the function(s) are implemented in software that is stored, e.g., in the memory 1106 and executed by the one or more processors 1104.

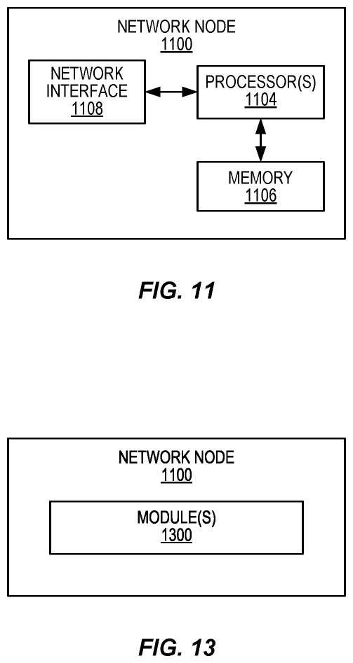

FIG. 12 is a schematic block diagram that illustrates a virtualized embodiment of the network node 1100 according to some embodiments of the present disclosure. This discussion is equally applicable to other types of network nodes. Further, other types of network nodes may have similar virtualized architectures. Again, optional features are represented by dashed boxes.

As used herein, a “virtualized” network node is an implementation of the network node 1100 in which at least a portion of the functionality of the network node 1100 is implemented as a virtual component(s) (e.g., via a virtual machine(s) executing on a physical processing node(s) in a network(s)). As illustrated, in this example, the network node 1100 includes one or more processing nodes 1200 coupled to or included as part of a network(s) 1202. Each processing node 1200 includes one or more processors 1204 (e.g., CPUs, ASICs, FPGAs, and/or the like), memory 1206, and a network interface 1208. In this example, functions 1210 of the network node 1100 described herein (e.g., one or more functions of the TX node 302 or one or more functions of the RX node 304, as described herein) are implemented at one of the processing nodes 1200 or distributed across two or more of the processing nodes 1200 in any desired manner. In some particular embodiments, some or all of the functions 1210 of the network node 1100 described herein are implemented as virtual components executed by one or more virtual machines implemented in a virtual environment(s) hosted by the processing node(s) 1200.

In some embodiments, a computer program including instructions which, when executed by at least one processor, causes the at least one processor to carry out the functionality of the network node 1100 or a node (e.g., a processing node 1200) implementing one or more of the functions 1210 of the network node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

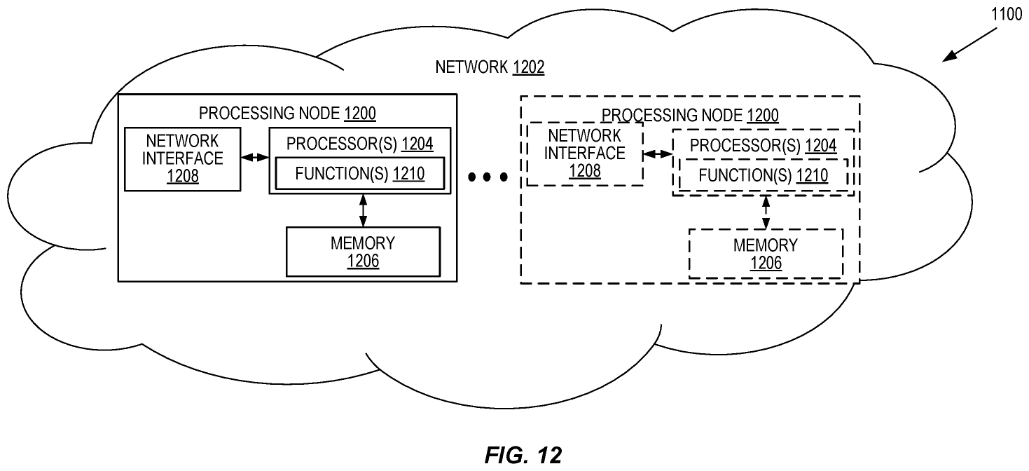

FIG. 13 is a schematic block diagram of the network node 1100 according to some other embodiments of the present disclosure. The network node 1100 includes one or more modules 1300, each of which is implemented in software. The module(s) 1300 provide the functionality of the network node 1100 304 described herein (e.g., one or more functions of the TX node 302 or one or more functions of the RX node 304, as described herein). This discussion is equally applicable to the processing node 1200 of FIG. 12 where the modules 1300 may be implemented at one of the processing nodes 1200 or distributed across multiple processing nodes 1200.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method performed by a transmit node (302) for a network for packet or frame replication, the method comprising one or more of the following steps:
determining (700) that a sequence generation function (310) at the transmit node (302) has been reset;
responsive to determining (700) that the sequence generation function (310) at the transmit node (302) has been reset, transmitting (702) a first plurality of packets in a Stream of packets, wherein: (a) each of the first plurality of packets comprises a respective sequence number from a linear sequence number space and (b) at least a first packet from among the first plurality of packets that was sent after the rest further comprises an explicit indicator of the reset;
determining (704) that an end of the linear sequence number space has been reached or that use of the linear sequence number space has been otherwise disabled; and
responsive to determining (704) that the end of the linear sequence number space has been reached or that use of the linear sequence number space has been otherwise disabled, transmitting (706) a second plurality of packet in the Stream of packets, wherein (a) each of the second plurality of packets comprises a respective sequence number of a cyclic sequence number space.

Embodiment 2: The method of embodiment 1 wherein each of the first plurality of packets further comprises an explicit indication that the linear sequence number space is being used.

Embodiment 3: The method embodiment 1 or 2 wherein the network is a Time-Sensitive Networking, TSN, network.

Embodiment 4: The method of any one of embodiments 1 to 3 further comprising resetting the sequence generation function (310), wherein resetting the sequence generation function (310) comprises resetting a sequence number history, a history window, or both the sequence number history and the history window

Embodiment 5: The method of embodiment 3 wherein the steps of determining (700) that the sequence generation function (310) at the transmit node (302) has been reset, transmitting (702) the first plurality of packets in the Stream of packets, determining (704) that the end of the linear sequence number space has been reached or that use of the linear sequence number space has been otherwise disabled, and transmitting (706) the second plurality of packet in the Stream of packets are performed by a Frame Replication and Elimination for Reliability, FRER, function (308) of the transmit node (302).

Embodiment 6: The method embodiment 1 or 2 wherein the network is a Deterministic Networking, DetNet, network.

Embodiment 7: The method of embodiment 6 wherein the steps of determining (700) that the sequence generation function (310) at the transmit node (302) has been reset, transmitting (702) the first plurality of packets in the Stream of packets, determining (704) that the end of the linear sequence number space has been reached or that use of the linear sequence number space has been otherwise disabled, and transmitting (706) the second plurality of packet in the Stream of packets are performed by a Packet Replication and Elimination Function, PRER, of the transmit node (302).

Embodiment 8: A method performed by a receive node (304) for a network for packet or frame elimination, the method comprising one or more of the following steps:
receiving (900) a packet from one of a plurality of replicated streams that traverse different paths from a transmit node (302) to the receive node (304) through the network, the packet comprising a sequence number;
determining (924, YES) that the packet comprises an explicit indication that a linear sequence number space is being used;
determining (926) whether the packet comprises an explicit indication that a sequence generation function (310) at the transmit node (302) has been reset;
determining (926) whether the sequence number of the packet is outside of a reset ignore range, iRIR, associated with use of the linear sequence number space;
responsive to determining that the packet comprises the explicit indication that the linear sequence number space is being used (924, YES) and that the packet comprises the explicit indication that the sequence generation function (310) at the transmit node (302) has been reset and the sequence number of the packet is outside of the iRIR (926, YES), accepting (918) the packet.

Embodiment 9: The method of embodiment 8 further comprising, responsive to determining that the packet comprises the explicit indication that the linear sequence number space is being used (924, YES) and that the packet comprises the explicit indication that the sequence generation function (310) at the transmit node (302) has been reset and the sequence number of the packet is outside of the iRIR (926, YES), updating (932; 934) the iHSW and the history associated with the linear sequence number space based on the sequence number of the packet.

Embodiment 10: The method of embodiment 8 further comprising, upon determining that the packet comprises the explicit indication that the linear sequence number space is being used (924, YES) and that the packet either does not comprise the explicit indication that the sequence generation function (310) at the transmit node (302) has been reset or the sequence number of the packet is not outside of the iRIR (926, NO):
determining (928) whether the sequence number of the packet is within a history window, iHSW, associated with the use of the linear sequence number space;
determining (930) whether the sequence number of the packet is already in a history associated with the use of the linear sequence number space that comprises sequence numbers that have already been received; and
responsive to determining (928, YES) that the sequence number of the packet is within the iHSW and determining (930, NO) that the sequence number of the packet is not already in the history, accepting (918) the packet.

Embodiment 11: The method of embodiment 10 further comprising, responsive to determining (928, YES) that the sequence number of the packet is within the iHSW and determining (930, YES) that the sequence number of the packet is already in the history, discarding (918) the packet.

Embodiment 12: The method of embodiment 10 further comprising, responsive to determining (928, YES) that the sequence number of the packet is within the iHSW and determining (930, NO) that the sequence number of the packet is not already in the history, updating (932; 934) the iHSW and the history associated with the linear sequence number space based on the sequence number of the packet.

Embodiment 13: A method performed by a transmit node (302) for a network for packet or frame replication, the method comprising one or more of the following steps:
obtaining (600) a packet to be sent;
determining (602, NO) that the packet has not already been replicated by a prior network node in the network (e.g., determining that R-Tag is not already present in the packet);
determining (608) whether a sequence generation function (310) at the transmit node (302) has been reset;
enabling (610) an explicit indication in the packet that indicates that the sequence generation function (310) has been reset responsive to determining (608) that the sequence generation function (310) at the transmit node (302) has been reset; otherwise disabling (612) the explicit indication in the packet;
determining (616, YES) that a linear sequence number space is to be used;
responsive to determining (616, YES) that the linear sequence number space is to be used:
   enabling (618) an explicit indication in the packet that indicates that the linear sequence number space is being used; and
   adding (620) a sequence number from the linear sequence number space to the packet;
adding (628) a tag to the packet that indicates that it has been replicated;
providing (604) the packet for replication and transmission.

Embodiment 14: A network node (302; 304; 1100) adapted to perform the method of any one of embodiments 1 to 13.

Those skilled in the art will recognize improvements and modifications to the embodiments of the present disclosure. All such improvements and modifications are considered within the scope of the concepts disclosed herein.

1. A method performed by a transmit node for packet or frame replication, the method comprising:
determining that a sequence generation function at the transmit node has been reset;
responsive to determining that the sequence generation function at the transmit node has been reset, transmitting a first plurality of packets in a stream of packets via at least two disjoint paths through a network, wherein: (a) each of the first plurality of packets comprises a respective sequence number from a linear sequence number space and (b) at least a first packet from among the first plurality of packets that was sent after the reset further comprises an explicit indicator of the reset;
determining that an end of the linear sequence number space has been reached or that use of the linear sequence number space has been otherwise disabled; and
responsive to determining that the end of the linear sequence number space has been reached or that the use of the linear sequence number space has been otherwise disabled, transmitting a second plurality of packets in the stream of packets via at least two disjoint paths through the network, wherein each of the second plurality of packets comprises a respective sequence number of a cyclic sequence number space.

2. The method of claim 1 wherein each of the first plurality of packets further comprises an explicit indication that the linear sequence number space is being used.

3. The method of claim 1 wherein the network is a Time-Sensitive Networking, TSN, network.

4. The method of claim 1 further comprising resetting the sequence generation function, wherein resetting the sequence generation function comprises resetting a sequence number history, a history window, or both the sequence number history and the history window.

5. The method of claim 3 wherein the steps of determining that the sequence generation function at the transmit node has been reset, transmitting the first plurality of packets in the stream of packets, determining that the end of the linear sequence number space has been reached or that the use of the linear sequence number space has been otherwise disabled, and transmitting the second plurality of packets in the stream of packets are performed by a Frame Replication and Elimination for Reliability, FRER, function of the transmit node.

6. The method of claim 1 wherein the network is a Deterministic Networking, DetNet, network.

7. The method of claim 6 wherein the steps of determining that the sequence generation function at the transmit node has been reset, transmitting the first plurality of packets in the stream of packets, determining that the end of the linear sequence number space has been reached or that the use of the linear sequence number space has been otherwise disabled, and transmitting the second plurality of packets in the stream of packets are performed by a Packet Replication and Elimination Function, PRER, of the transmit node.

8. (canceled)

9. (canceled)

10. A transmit node for packet or frame replication, the transmit node comprising:
a network interface; and
processing circuitry associated with the network interface, the processing circuitry configured to cause the transmit node to:
determine that a sequence generation function at the transmit node has been reset;
responsive to determining that the sequence generation function at the transmit node has been reset, transmit a first plurality of packets in a stream of packets via at least two disjoint paths through a network, wherein: (a) each of the first plurality of packets comprises a respective sequence number from a linear sequence number space and (b) at least a first packet from among the first plurality of packets that was sent after the reset further comprises an explicit indicator of the reset;
determine that an end of the linear sequence number space has been reached or that use of the linear sequence number space has been otherwise disabled; and
responsive to determining that the end of the linear sequence number space has been reached or that the use of the linear sequence number space has been otherwise disabled, transmit a second plurality of packets in the stream of packets via at least two disjoint paths through the network, wherein (a) each of the second plurality of packets comprises a respective sequence number of a cyclic sequence number space.

11. (canceled)

12. A method performed by a transmit node for packet or frame replication, the method comprising:
obtaining a packet to be sent;
determining that the packet does not comprise a tag that indicates that the packet has already been replicated;
responsive to determining that the packet does not comprise the tag that indicates that the packet has already been replicated:
determining that a linear sequence number space is to be used;
responsive to determining that the linear sequence number space is to be used:
enabling an explicit indication in the packet that indicates that the linear sequence number space is being used; and
adding a sequence number from the linear sequence number space to the packet; and
adding a tag to the packet that indicates that the packet has been replicated; and
providing the packet for replication and transmission.

13. The method of claim 12 further comprising, responsive to determining that the packet does not comprise a tag that indicates that the packet has already been replicated:
determining that a sequence generation function at the transmit node has been reset; and
enabling an explicit indication in the packet that indicates that the sequence generation function has been reset responsive to determining that the sequence generation function at the transmit node has been reset, otherwise disabling the explicit indication in the packet that indicates that the sequence generation function has been reset.

14. The method of claim 12 further comprising, responsive to determining that the linear sequence number space is to be used, incrementing the sequence number from the linear sequence number space.

15. The method of claim 14 further comprising repeating the method of claim 14 for a plurality of additional packets until the linear sequence number space is exhausted or use of the linear sequence number space is otherwise disabled.

16. The method of claim 15 further comprising, after the linear sequence number space is exhausted or after the use of the linear sequence number space is otherwise disabled:
obtaining a further packet to be sent;
determining that the further packet does not comprise a tag that indicates that the further packet has already been replicated;
responsive to determining that the further packet does not comprise a tag that indicates that the further packet has already been replicated:
determining that a cyclic sequence number space, rather than a linear sequence number space, is to be used;
responsive to determining that the cyclic sequence number space is to be used:
disabling an explicit indication in the further packet that indicates that the linear sequence number space is being used; and
adding a sequence number from the cyclic sequence number space to the further packet; and
adding the tag to the further packet that indicates that the further packet has been replicated; and
providing the further packet for replication and transmission.

17. The method of claim 16 further comprising, responsive to determining that the further packet does not comprise a tag that indicates that the further packet has already been replicated:
determining whether the sequence generation function at the transmit node has been reset; and
enabling an explicit indication in the further packet that indicates that the sequence generation function has been reset responsive to determining that the sequence generation function at the transmit node has been reset, otherwise disabling the explicit indication in the further packet that indicates that the sequence generation function has been reset.

18. (canceled)

19. (canceled)

20. A transmit node for packet or frame replication, the transmit node comprising:
a network interface; and
processing circuitry associated with the network interface, the processing circuitry configured to cause the transmit node to:
obtain a packet to be sent;
determine that the packet does not comprise a tag that indicates that the packet has already been replicated;
responsive to determining that the packet does not comprise the tag that indicates that the packet has already been replicated:
determine that a linear sequence number space is to be used;
responsive to determining that the linear sequence number space is to be used:
enable an explicit indication in the packet that indicates that the linear sequence number space is being used; and
add a sequence number from the linear sequence number space to the packet; and
add the tag to the packet that indicates that the packet has been replicated; and
provide the packet for replication and transmission.

21. (canceled)

22. A method performed by a receive node for packet or frame elimination, the method comprising:
receiving a packet from one of a plurality of replicated streams that traverse disjoint paths from a transmit node to the receive node through a network, the packet comprising a sequence number;
determining that the packet comprises an explicit indication that a linear sequence number space, rather than a cyclic sequence number space, is being used;
determining whether the packet comprises an explicit indication that a sequence generation function at the transmit node has been reset;
determining whether the sequence number of the packet is outside of a reset ignore range, iRIR, associated with use of the linear sequence number space; and
responsive to determining that the packet comprises the explicit indication that the linear sequence number space is being used and that the packet comprises the explicit indication that the sequence generation function at the transmit node has been reset and the sequence number of the packet is outside of the iRIR, accepting the packet.

23. The method of claim 22 further comprising, responsive to determining that the packet comprises the explicit indication that the linear sequence number space is being used and that the packet comprises the explicit indication that the sequence generation function at the transmit node has been reset and the sequence number of the packet is outside of the iRIR, updating a history window and a history associated with the linear sequence number space based on the sequence number of the packet.

24. The method of claim 22 further comprising, upon determining that the packet comprises the explicit indication that the linear sequence number space is being used and that the packet either does not comprise the explicit indication that the sequence generation function at the transmit node has been reset or the sequence number of the packet is not outside of the iRIR:
determining whether the sequence number of the packet is within a history window, iHSW, associated with the use of the linear sequence number space;
determining whether the sequence number of the packet is already in a history associated with the use of the linear sequence number space that comprises sequence numbers from the linear sequence number space that have already been received; and
responsive to determining that the sequence number of the packet is within the iHSW and determining that the sequence number of the packet is not already in the history, accepting the packet.

25. The method of claim 24 further comprising, responsive to determining that the sequence number of the packet is within the iHSW and determining that the sequence number of the packet is already in the history, discarding the packet.

26. The method of claim 24 further comprising, responsive to determining that the sequence number of the packet is within the iHSW and determining that the sequence number of the packet is not already in the history, updating the iHSW and the history associated with the linear sequence number space based on the sequence number of the packet.

27. (canceled)

28. (canceled)

29. A receive node for packet or frame elimination, the receive node comprising:
a network interface; and
processing circuitry associated with the network interface, the processing circuitry configured to cause the receive node to:
receive a packet from one of a plurality of replicated streams that traverse disjoint paths from a transmit node to the receive node through a network, the packet comprising a sequence number;
determine that the packet comprises an explicit indication that a linear sequence number space, rather than a cyclic sequence number space, is being used;
determine whether the packet comprises an explicit indication that a sequence generation function at the transmit node has been reset;
determine whether the sequence number of the packet is outside of a reset ignore range, iRIR, associated with use of the linear sequence number space; and
responsive to determining that the packet comprises the explicit indication that the linear sequence number space is being used and that the packet comprises the explicit indication that the sequence generation function at the transmit node has been reset and the sequence number of the packet is outside of the iRIR, accept the packet.

30. (canceled)
